(19) United States
(12) Patent Application Publication
(10) Pub. No.: US 2004/0221479 A1
(43) Pub. Date: Nov. 11, 2004

(54) Structure of top cover in clothes dryer

(75) Inventors: Soon Jo Lee, Changwon-si (KR); Seong Hai Jeong, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 10/663,997

(22) Filed: Sep. 17, 2003

(30) Foreign Application Priority Data
Sep. 18, 2002 (JP) P 2002-00056976

(51) Int. Cl. F26B 11/02

(52) U.S. Cl. 34/603

(57) ABSTRACT

A structure of a top cover of a clothes dryer for effectively preventing water flown through a prefabricated hole at a control panel on the top cover from being flowed to electric accessories is disclosed. The clothes dryer includes a base forming a floor of a body, a front cabinet forming a front of the body, a side cabinet forming a side of the body, a back cover forming a back side of the body, a top cover forming a top of the body, and the control panel 6 provided on a rear of the top cover 5. The top cover includes predetermined curvature in all direction along the body B, a groove provided along the body B at a rear side thereof, a prefabricated hook provided on a front surface of the control panel and inserted to the groove, and a fire wall made of metal and provided at a lower part thereof.

### CROSS-REFERENCE TO RELATED APPLICATIONS

This application claims the benefit of Korean Application No. P2002-56976, filed on Sep. 18, 2003, which is hereby incorporated by reference as if fully set forth herein.

### BACKGROUND OF THE INVENTION

1. Field of the Invention

The present invention relates to a clothes dryer, and more particularly, to a structure of a top cover in the clothes dryer.

2. Discussion of the Related Art

In general, a clothes dryer is an apparatus for drying a wet article (for example, (clothes) and is composed as follows. FIG. 1 is a bird-eye view illustrating an external view of a clothes dryer. Body B of the clothes dryer includes a base 1 forming a floor, a front cabinet 2 forming a front of the clothes dryer, a side cabinet 3 forming a side of the clothes dryer, a back cover 4 forming a back side of the clothes dryer, a top cover 5 forming a top of the clothes dryer, and a control panel 6 provided on a rear of the top cover 5.

The front cabinet 2 forming a structural element of the body of the conventional clothes dryer includes an opening for putting the respective article in and out thereof. A drum for drying (not illustrated) is rotatably provided in the body of the clothes dryer for receiving driving force and rotating. A door is also provided to selectively open and close the opening on the front cabinet 2.

A hot-air supply channel and a hot-air discharge channel are connected to the drying drum. A heater (not illustrated) is provided on the hot-air supply channel for heating air flowed in from the exterior of the dryer and a fan (not illustrated) is provided on the hot-air discharge channel for blowing the air heated by the heater to an outside of the body B after drying clothes is finished.

An operation of the clothes dryer will be described as follows. First, the heater and a motor (not illustrated) runs if the drying administration is carried out after an wet article is inputted to an inside of the drying drum. According to an operation of a ventilating fan, outside air flowed to an inside of the body B through a sucking side of the hot-air supplying channel is changed into hot-air passing through the heater, and flowed to the inside of the drying drum through the hot-air supplying channel.

To this end, the hot-air repeats the steps of being flowed to the inside of the drying drum by the sucking force of the discharging fan, evaporating moisture of the wet article and being discharged to the outside of the body B through a discharging side of the hot-air discharge channel. At this time, the drying drum receives operating force of the motor and slowly rotates. The wet article is dried in the process.

However, the conventional clothes dryer has a problem as follows. When water is split on a top surface of the top cover 5, water flows through a prefabricated hole on the control panel 530, falls down to a lower part, flows to various electric accessories and causes a short circuit as illustrated in FIG. 2.

### SUMMARY OF THE INVENTION

Accordingly, the present invention is directed to a structure of a top cover in the clothes dryer that substantially obviates one or more problems due to limitations and disadvantages of the related art.

An object of the present invention is to provide a structure of a top cover in the clothes dryer for discharging water spilt on a top surface of the top cover and water flowed down through a prefabricated hole at the control panel to an outside, and for preventing water from being flowed to the inside of the electric accessories in the clothes dryer.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a structure of a top cover in a clothes dryer includes a base forming a floor of a body, a front cabinet forming a front surface of the body, a side cabinet forming a side of the clothes dryer, a back cover 4 forming a back side of the body, a top cover provided on a top surface of the front cabinet, the side cabinet and the back cover, and a control panel provided on a rear side of the top cover. The top cover includes predetermined curvature around the body in all direction, a groove provided along the body at a rear side thereof, a prefabricated hook provided on a front surface of the control panel and inserted to the groove, and a fire wall made of metal and provided at a lower part thereof.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a bird-eye view illustrating an exterior of a conventional clothes dryer.

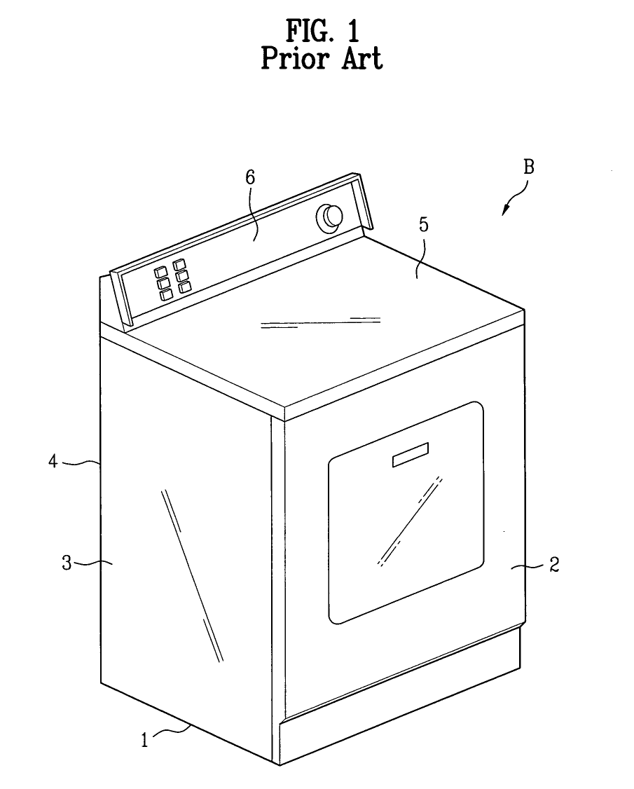

FIG. 2 is a cross-sectional view illustrating a principle part of FIG. 1.

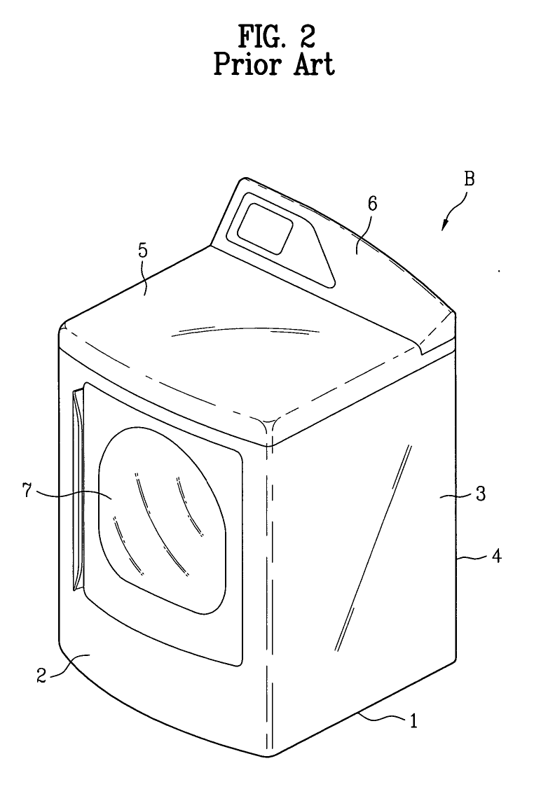

FIG. 3 is a bird-eye view illustrating an exterior of a clothes dryer of the present invention.

FIG. 4 is a cross-sectional view illustrating a principle part of FIG. 3.

FIG. 5 is a bird-eye view illustrating an exterior of a clothes dryer for describing a state that a control panel is removed from FIG. 3

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

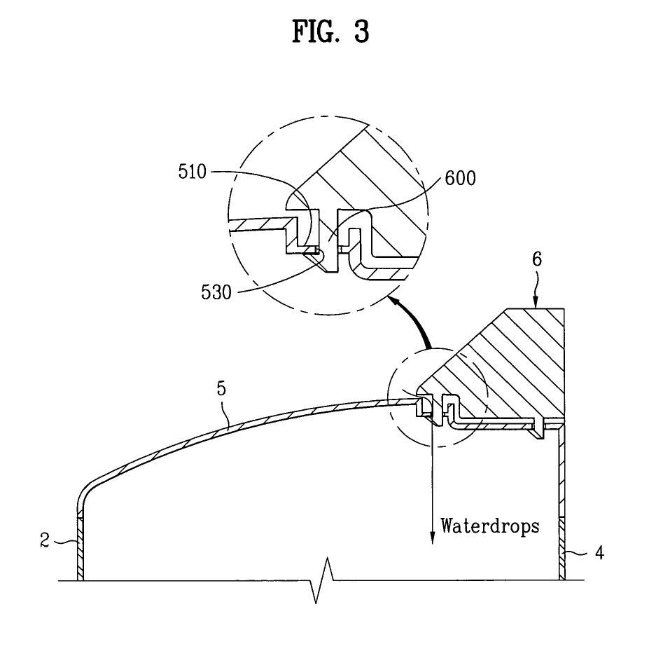

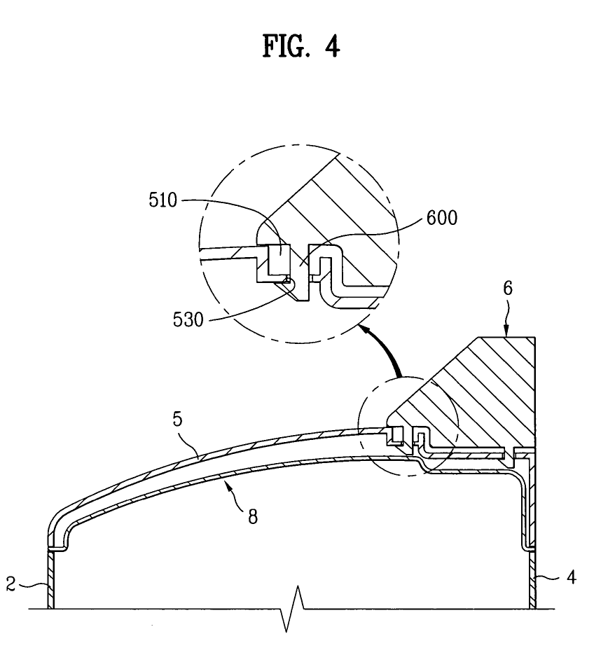

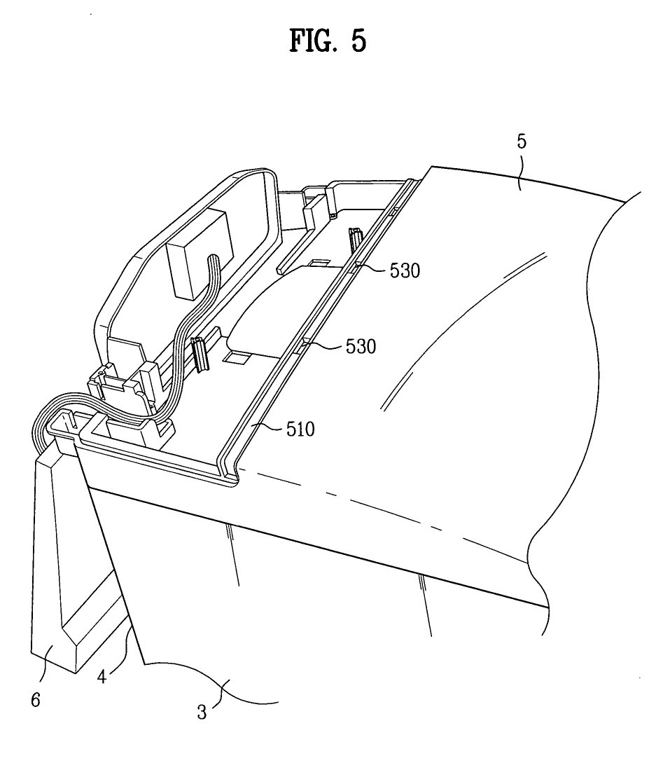

Hereinafter, a preferred embodiment of the present invention will be described referring to FIG. 3 to FIG. 5. FIG. 3 is a bird-eye view illustrating an exterior of a clothes dryer of the present invention. FIG. 4 is a cross-sectional view illustrating a principle part of FIG. 3. FIG. 5 is a bird-eye view illustrating an exterior of a clothes dryer for describing a state that a control panel is removed from FIG. 3.

A body B of the clothes dryer includes a base 1 forming a floor of the body B, a front cabinet 2 forming a front surface of the body B, a side cabinet 3 forming a side of the clothes dryer, a back cover 4 forming a back side of the body B, a top cover 5 provided on a top surface of the front cabinet 2, the side cabinet 3 and the back cover 4, and a control panel 6 provided on a rear side of the top cover. The top cover 5 includes predetermined curvature around the body B in all direction, a groove 510 provided along the body B at a rear side thereof, a prefabricated hook 600 provided on a front surface of the control panel 6 and inserted to the groove 510, and a fire wall 8 made of metal and provided at a lower part thereof.

In this case, it is desired that the fire wall 8 provided at the lower part of the top cover 5 has curvature of the top cover 5 and also the groove 510 provided in left or right direction along the body B at the rear side of the top cover 5 has curvature of the top cover 5.

Mechanism of the present invention as aforementioned is as follows. The clothes dryer of the present invention has a structure that water does not flow to the inside of the top cover 5 when water is split on the top surface of the top cover 5. If water flowed to the inside of the top cover through the prefabricated hole 530 provided on the top cover, water falls down to the lower part of the body and water is prevented from being flowed to the various electric accessories.

In other words, the clothes dryer of the present invention has the prefabricated hole 530 provided in the groove 510 provided at the rear side of the body B in left and right direction. Therefore, when water is spilt on the top surface of the top cover 5, most of water flows along curvature of the groove 510 to outside of the body B.

Meanwhile, a part of water flowed to the inside of the body B through the prefabricated hole 530 falls down on a top surface of the fire wall 8 provided at the lower part of the top cover 5. Water fallen to the top surface of the fire wall 8 flows to the outside of the body B along the top surface of the fire wall 8 having curvature. Therefore, the water is prevented from flowing to the various electric accessories provided at the lower part of the fire wall 8 according to the present invention.

As aforementioned, the clothes dryer of the present invention is to prevent water from being flowed to the inside of the electric accessories in the clothes dryer through the prefabricated hole of the control panel on the top cover. Therefore, the present invention has an effect of reliability that accidents such as a short circuit generated by water flowed to the electric accessories.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A structure of a tope cover of a clothes dryer, comprising:
a base forming a floor of a body;
a front cabinet 2 forming a front of the body;
a side cabinet 3 forming a side of the body;
a back cover 4 forming a back side of the body;
a top cover 5 forming a top of the body, the top cover comprising:
a predetermined curvature around the body in all direction;
a groove 510 provided along the body at a rear side of the top cover;
a prefabricated hook 600 provided on a front surface of the control panel, and inserted to the groove 510; and
a fire wall 8 made of metal, and provided at a lower part thereof; and
a control panel 6 provided on a rear of the top cover 5.

2. The structure of the top cover of the clothes dryer of claim 1, wherein the fire wall provided at a lower part of the top cover is formed to have the same curvature as that of the top cover.

3. The structure of the top cover of the clothes dryer of claim 1, wherein the groove provided at a rear side of the top cover in left and right direction is comprised to have the same curvature as that of the top cover.
